(19) United States
(12) Patent Application Publication
(10) Pub. No.: US 2014/0289596 A1
(43) Pub. Date: Sep. 25, 2014

(54) SYSTEMS AND METHODS FOR FACILITATING PLAYBACK OF MEDIA

(71) Applicants: Verizon Corporate Services Group Inc., Basking Ridge, NJ (US); RAYTHEON BBN TECHNOLOGIES CORP., CAMBRIDGE, MA (US)

(72) Inventors: Scott SHEPARD, Waltham, MA (US); Sean COLBATH, Cambridge, MA (US); Francis G. KUBALA, Boston, MA (US)

(73) Assignees: Verizon Corporate Services Group Inc., Basking Ridge, NJ (US); RAYTHEON BBN TECHNOLOGIES CORP., CAMBRIDGE, MA (US)

(21) Appl. No.: 14/270,544

(22) Filed: May 6, 2014

Related U.S. Application Data
(62) Division of application No. 10/610,534, filed on Jul. 2, 2003.

(51) Int. Cl. G06F 17/22

(52) U.S. Cl. CPC G06F 17/2247
USPC 715/203

(57) ABSTRACT

A system facilitates the browsing of information of interest. The system obtains a transcription of the information and provides the transcription to a user. The system also retrieves the information in its original format and presents the information to the user in the original format. The system visually synchronizes the presentation of the information in the original format with the transcription of the information

### RELATED APPLICATIONS

This application claims priority under 35 U.S.C. §119 based on U.S. Provisional Application Nos. 60/394,064 and 60/394,982, filed Jul. 3, 2002, and Provisional Application No 60/419,214, filed Oct. 17, 2002, the disclosures of which are incorporated herein by reference.

This application is related to U.S. patent application Ser. No. ______ (Docket No. 02-4038), entitled, “Systems and Methods for Aiding Human Translation,” filed concurrently herewith and incorporated herein by reference.

### GOVERNMENT CONTRACT

The U.S. Government may have a paid-up license in this invention and the right in limited circumstances to require the patent owner to license others on reasonable terms as provided for by the terms of Contract No. N66001-00-C-8008 awarded by the Defense Advanced Research Projects Agency (DARPA).

### BACKGROUND OF THE INVENTION

1. Field of the Invention

The present invention relates generally to multimedia environments and, more particularly, to systems and methods fir visually synchronizing the playback of any media (text, audio, video) with a textual representation of the media.

2. Description of Related Art

Much of the archived multimedia information that exists today is not easily manageable. For example, while mechanisms exist for searching and retrieving text, similar mechanisms do not exist for other types of media, such as audio or video. Audio and video from sources, such as television, radio, telephone, meetings, and presentations, have not been valued as archival sources due to the difficulty of locating inform ion in large audio or video archives.

Recently, automatic content-based indexing and retrieval tools have been developed that may make audio and video sources as valuable an archival resource as text. These tools have made it easier to find audio or video sources of interest. The tools do not, however, facilitate the perusal of these audio or video sources. To browse an audio source, for example, a user must listen to the audio source to determine if it was the one the user desired. A user cannot do this much faster than the rate at which the audio was recorded.

Accordingly, there is a need for mechanisms that facilitate the perusal of media sources.

### SUMMARY OF THE INVENTION

Systems and methods consistent with the present invention address this and other needs by visually synchronizing the playback of any media with a textual version of the media, thereby permitting a user to quickly skim or browse the media.

In one aspect consistent with the principles of the invention, a system facilitates the browsing of information of interest. The system obtains a transcription of the information and provides the transcription to a user. The system also retrieves the information in its original format and presents the information to the user in the original format. The system visually synchronizes the presentation of the information in the original format with the transcription of the information.

In another aspect consistent with the principles of the invention, a graphical user interface includes a transcription section, a speaker section, a topic section, and a request media button. The transcription section includes a transcription of non-text information. The speaker section identifies boundaries between speakers in the transcription section. The topic section includes one or more topics relating to the transcription. The request media button, when selected, causes retrieval of the non-text information to be initiated and the retrieved non-text information to be played. The request media button also causes the playing of the non-text information to be visually synchronized with the transcription in the transcription section.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram of a system in which systems and methods consistent with the present invention may be implemented;

FIG. 2 is an exemplary diagram of the server of FIG. 1 according to an implementation consistent with the principles of the invention;

FIG. 3 is an exemplary diagram of the metadata database of FIG. 1 according to an implementation consistent with the present invention;

FIG. 4 is an exemplary diagram of a metadata media file of FIG. 3 according to an implementation consistent with the principles of the invention;

FIG. 5 is an exemplary diagram of the database of original media of FIG. 1 according to an implementation consistent with the principles of the invention

FIG. 6 is an exemplary diagram of the client of FIG. 1 according to an implementation consistent with the principles of the invention;

FIG. 7 is an exemplary diagram of a graphical user interface that may be presented via the client of FIG. 6 according to an implementation consistent with the principles of the invention;

FIG. 8 is a flowchart of exemplary processing for visually synchronizing the playback of an original media with a textual representation of the media;

FIG. 9 is a diagram of a graphical user interface that illustrates a user's request to play back an original media; and

FIG. 10 is a diagram of a graphical user interface that illustrates the synchronization of a HyperText Markup Language document to the playback of the original media.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

Systems and methods consistent with the present invention visually synchronize the playing back of a type of media, such as text, audio, and/or video, with a textual representation of the media. Such systems and methods permit a user to quickly browse the media in any language.

### EXEMPLARY SYSTEM

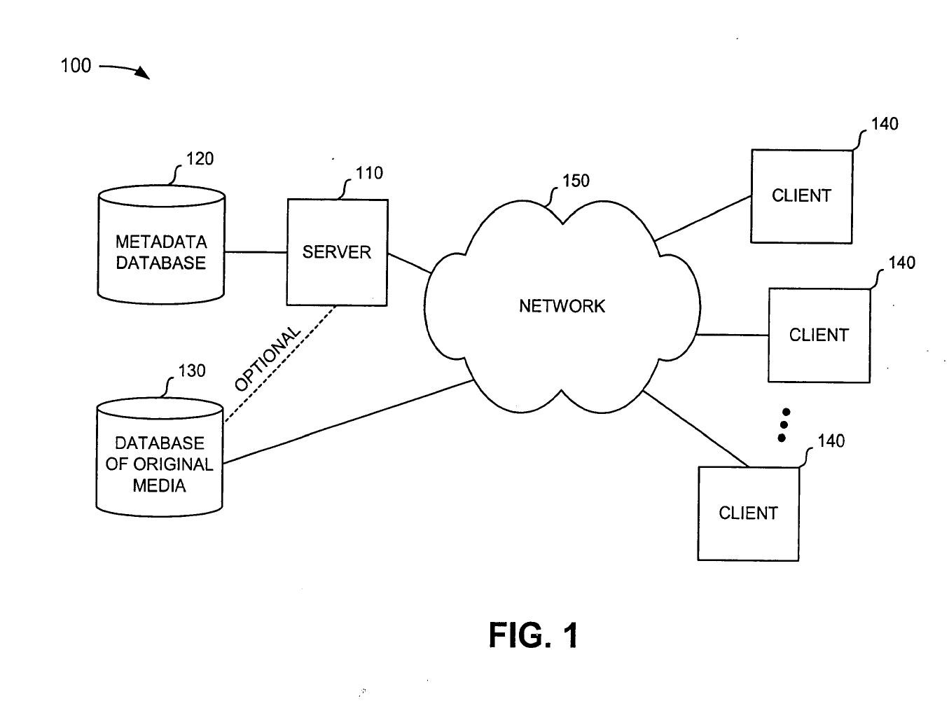

FIG. 1 is a diagram of an exemplary system 100 in which systems and methods consistent with the present invention may be implemented. System 100 may include server 110, metadata database 120, database of original media 130, and clients 140 interconnected via a network 150. Network 350 may include any type of network, such as a local area network (LAN), a wide area network (WAN), a public telephone network (e.g., the Public Switched Telephone Network (PSTN)) a virtual private network (VPN), or a combination of networks. Server 110, database 130, and clients 140 may connect to network 150 via wired, wireless, and/or optical connections.

Generally, clients 140 may interact with server 110 to obtain information of interest from metadata database 120. A user of one of clients 140 may peruse the information and obtain the original media from database of original media 130 either directly or via server 110. Client 140 may present the information and original media to the user in such a manner that facilitates the user's perusal of the information.

Each of the components of system 100 will now be described in more detail.

### Server 110

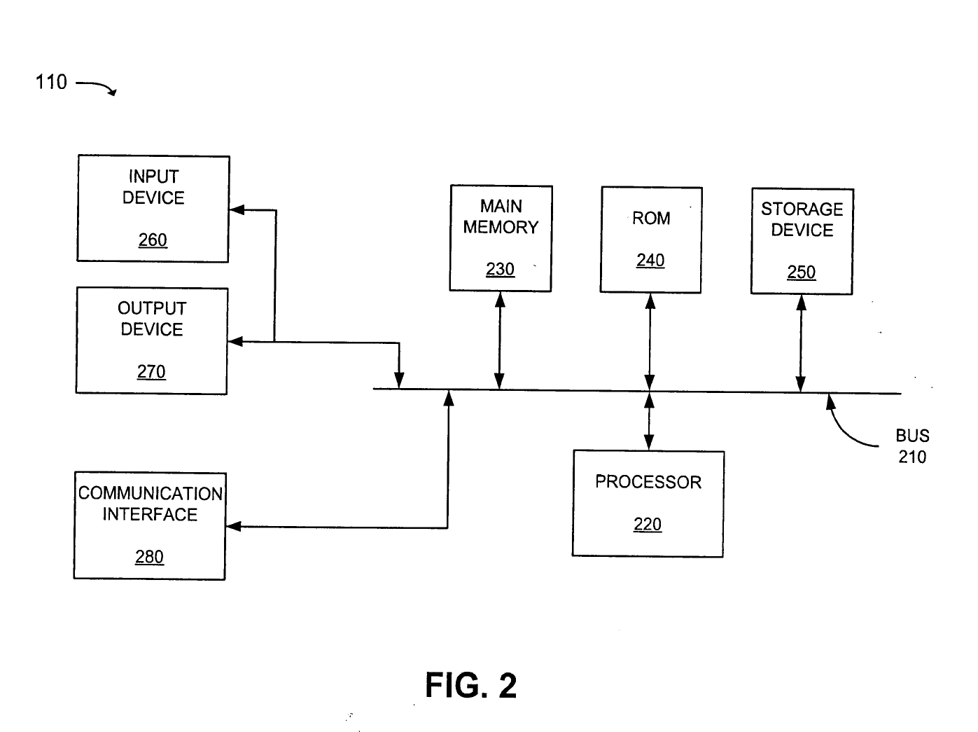

Server 110 may include a computer or another device that is capable of servicing client requests for information and providing such information to a client 140, possibly in the form of a HyperText Markup Language (HTML) document or web page. FIG. 2 is an exemplary diagram of server 110 according to an implementation consistent with the principles of the invention. Server 110 may include bus 210, processor 220, main memory 230, read only memory (ROM) 240, storage device 250, input device 260, output device 270, and communication interface 280. Bus 210 permits communication among the components of server 110.

Processor 220 may include any type of conventional processor or microprocessor that interprets and executes instructions. Main memory 230 may include a random access memory (RAM) or another type of dynamic storage device that stores information and instructions for execution by processor 220 ROM 240 may include a conventional ROM device or another type of static storage device that stores static information and instructions for use by processor 220. Storage device 250 may include a magnetic and/or optical recording medium and its corresponding drive.

Input device 260 may include one or more conventional mechanisms that permit an operator to input information to server 110, such as a keyboard, a mouse, a pen, voice recognition and/or biometric mechanisms, etc. Output device 270 may include one or more conventional mechanisms that output information to the operator, including a display, a printer, a pair of speakers, etc. Communication interface 280 may include any transceiver-like mechanism that enables server 110 to communicate with other devices and/or systems. For example, communication interface 280 may include mechanisms for communicating with another device or system via a network, such as network 150.

As will be described in detail below, server 110, consistent with the present invention, services requests for information and manages access to metadata database 120. Server 110 may perform these tasks in response to processor 220 executing sequences of instructions contained in, for example, memory 230. These instructions may be read into memory 230 from another computer-readable medium, such as storage device 250, or from another device via communication interface 280.

Execution of the sequences of instructions contained in memory 230 causes processor 220 to perform processes that will be described later. Alternatively, hardwired circuitry ma be used in place of or in combination with software instructions to implement processes consistent with the present invention. Thus, processes performed by serer 110 are not limited to any specific combination of hardware circuitry and software.

### Metadata Database 120

Metadata database 120 may include a conventional database that stores metadata relating to any type of media in any language. A media processing system (not shown), such as the one described in John Makhoul et al., “Speech and Language Technologies for Audio indexing and Retrieval,” Proceedings of the IEEE, Vol. 88, No. 8. August 2000, pp. 1338-1353, may collect media from various sources, process the media, and create metadata relating to the original media.

In the case of studio or video, the media processing system may segment an input stream by speaker, cluster audio segments from the same speaker, identify speakers known to the system, and transcribe the spoken words. The media processing system may also segment the input stream into stories, based on their topic content, and locate the names of people, places, and organizations. The media processing system may further analyze the input stream to identify when each word is spoken. The media processing system may include any or all of this information in the metadata relating to the input stream.

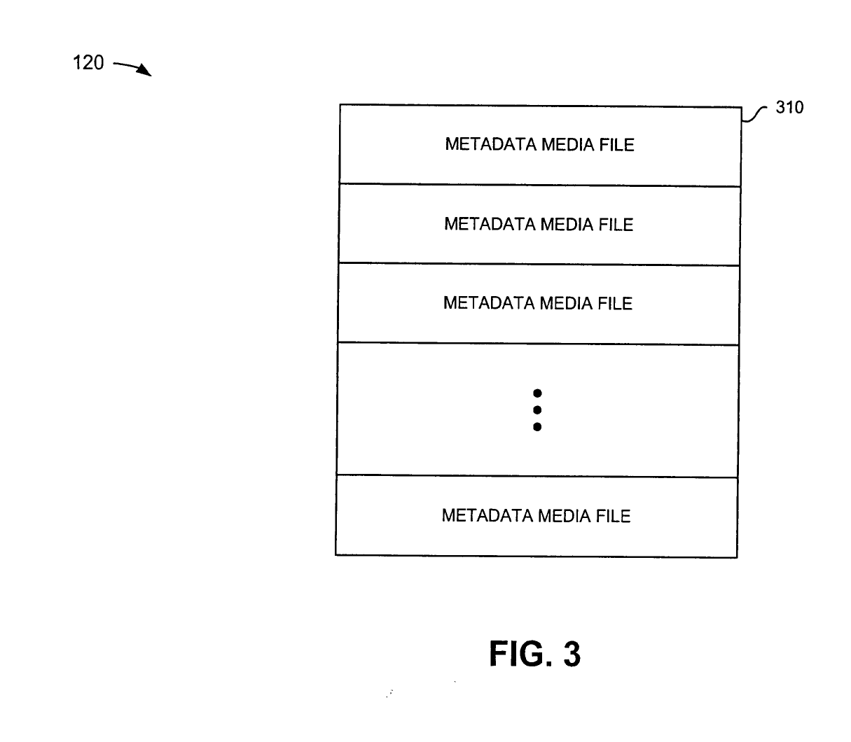

Metadata database 120 may store metadata in files or tables. FIG. 3 is an exemplary diagram of metadata database 120 according to an implementation consistent with the principles of the invention. Metadata database 120 may include multiple metadata media files 310. Each of media files 310 may stole metadata relating to a story or an episode (i.e., a collection of stories within an input stream). The metadata ma differ depending on the type of media to which it corresponds. For a text input stream, for example, the metadata may include information relating to an author or publisher of the text. For an audio input stream, the metadata may include information regarding a speaker, or speakers, or a source of the audio. For a video input stream, the metadata ma include information regarding, one or more persons in the video (speaking or non-speaking) or a source of the video.

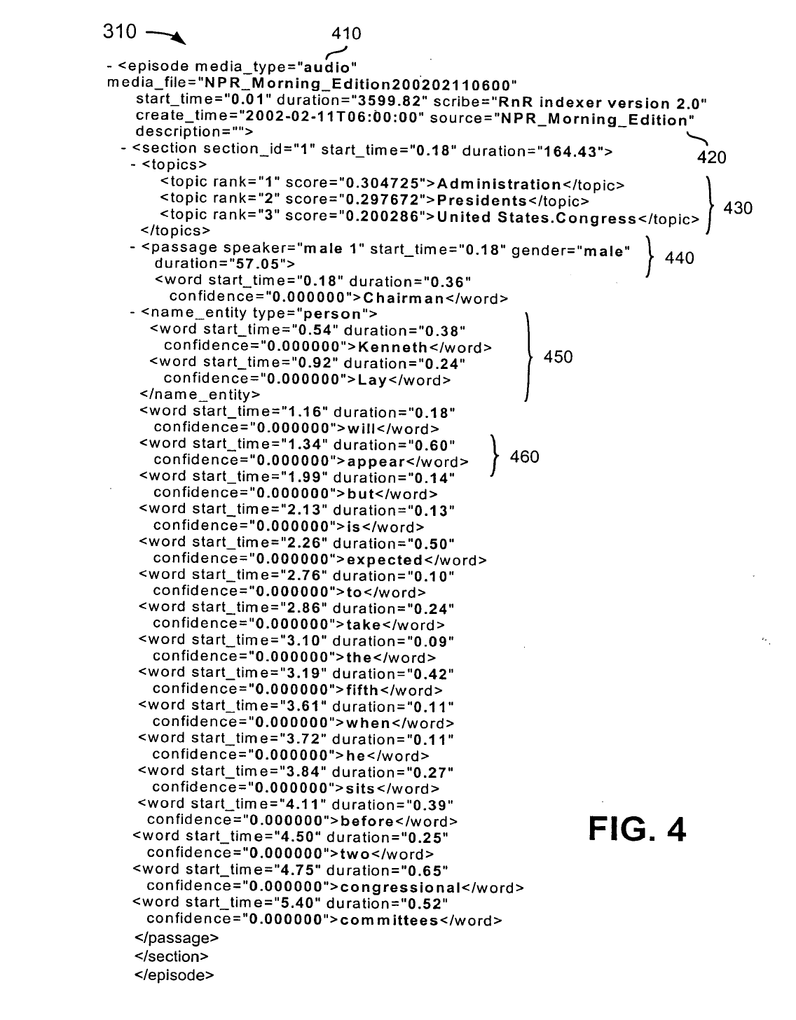

FIG. 4 is a diagram of an exemplary metadata media tile 310 according to an implementation consistent with the principles of the invention. Media file 310 in FIG. 4 relates to an audio input stream from National Public Radio (NPR) Morning Edition on Feb. 11, 2002, that began at 6:00 a.m. The metadata in media file 310 ma include information 410 regarding the type of media involved (audio) and information 420 that identifies the source of the input stream (NPR Morning Edition). The metadata may also include data 430 that identifies relevant topics, data 440 that identifies speaker gender, and data 450 that identifies names of people, places, or organizations. The metadata may further include time data 460 that identifies the start and duration of each word spoken.

### Database of Original Media 130

Database of original media 130 may include a conventional database that stores any type of media in any language. The media stored in database 130 may correspond to the metadata in metadata database 120, in other words, the original media may include the data from which the metadata was created. In other implementations, database 130 may contain additional media for which there is no corresponding metadata in metadata database 120.

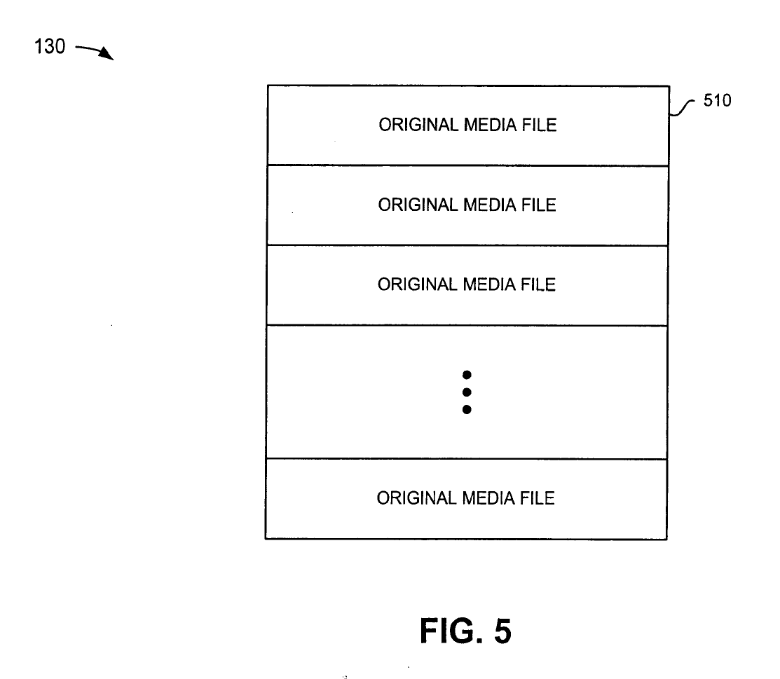

FIG. 5 is an exemplary diagram of database of original media 130 according to an implementation consistent with the principles of the invention. Database 130 may include multiple original media files 510. Each of media files 510 may store data from an original input stream. For example, a media file 510 may correspond to an audio stream. In this case, the audio stream may be processed by a known audio compression technique, such as MP3 compression, and stored in media file 510. Another media file 510 may correspond to a video stream. In this case, the video stream may be processed by a known video compression technique, such as MPEG compression, and stored in media file 510. Yet another media file 510 may correspond to a text stream, such as news wire. In this case, the text stream may be processed by a known text compression technique and stored in media file 510. Where storage space is not limited, the media may be stored uncompressed.

The original media um be stored in such a way that it is easily retrievable as a whole and in portions. For example, a portion of an audio file may be retrieved by specifying that the portion of the file that, occurred between 8:05 a.m. and 8:08 a.m. is desired. The database 130 may then provide, the desired audio as streaming audio to client 140, for example.

### Client 140

Client 140 may include a personal computer, a laptop, a personal digital assistant, or another type of device that is capable of interacting with server 110 and database of original media 130 to obtain information of interest. Client 140 may present the information to a user via a graphical user interface (GUI), possibly within a web browser window.

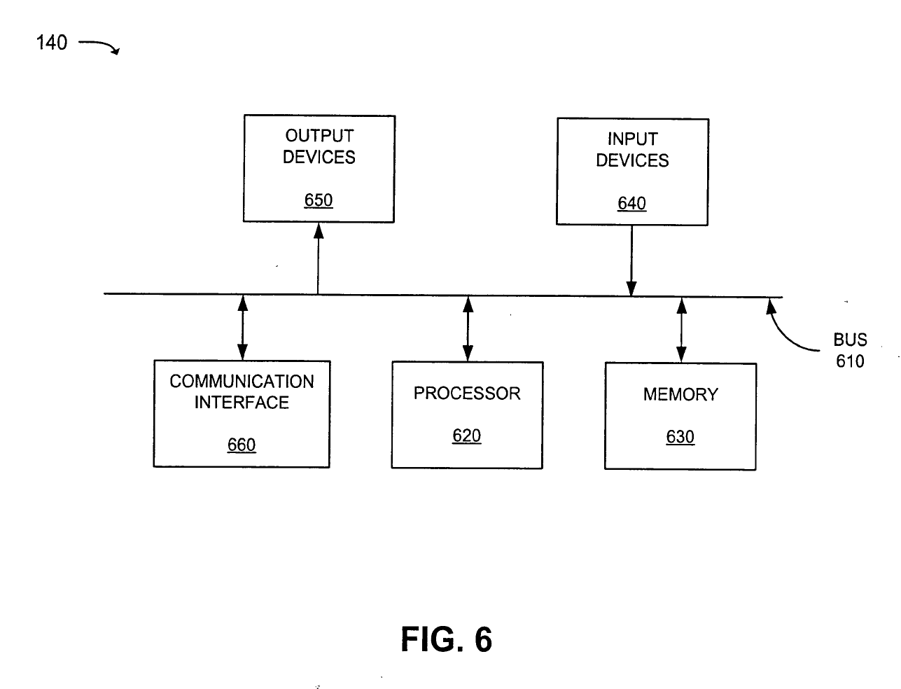

FIG. 6 is an exemplary diagram of client 140 according to an implementation consistent with the principles of the invention. Client 140 may include a bus 610, a processor 620, a memory 630, one or more input devices 640, one or more output devices 650, and a communication interface 660. Bus 610 may permit communication among the components of client 140.

Processor 620 may include any type of conventional processor or microprocessor that interprets and executes instructions. Memory 630 may include a RAM or another type of dynamic storage device that stores information and instructions for execution by processor 620; a ROM or another type of static storage device that stores static information and instructions for use by processor 620; and/or some other type of magnetic or optical recording medium and its corresponding drive. For example, memory 630 may include both long term and short term memory devices.

Input devices 640 may include one or more conventional mechanisms that permit a user to input information into client 140, such as a keyboard, mouse, pen, etc. Output devices 650 may include one or more conventional mechanisms that output information to the user, including a display, a printer, a pair of speakers, etc. Communication interface 660 may include any transceiver-like mechanism that enables client 140 to communicate with other devices and systems via a network such as network 150.

As will be described in detail below, client 140, consistent with the present invention, visually synchronizes the playing back of a type of media, such as text, audio, and/or video, with a textual representation of the media. Client 140 may perform these operations in response to processor 620 executing software instructions contained in a computer-readable medium, such as memory 630. The software instructions may be read into memory 630 from another computer-readable medium or from another device via communication interface 660. The software instructions contained in memory 630 causes processor 620 to perform processes that will be described later. Alternatively, hardwired circuitry may be used in place of or in combination with software instructions to implement processes consistent with the present invention. Thus, processes performed by client 140 are not limited to any specific combination of hardware circuitry and software.

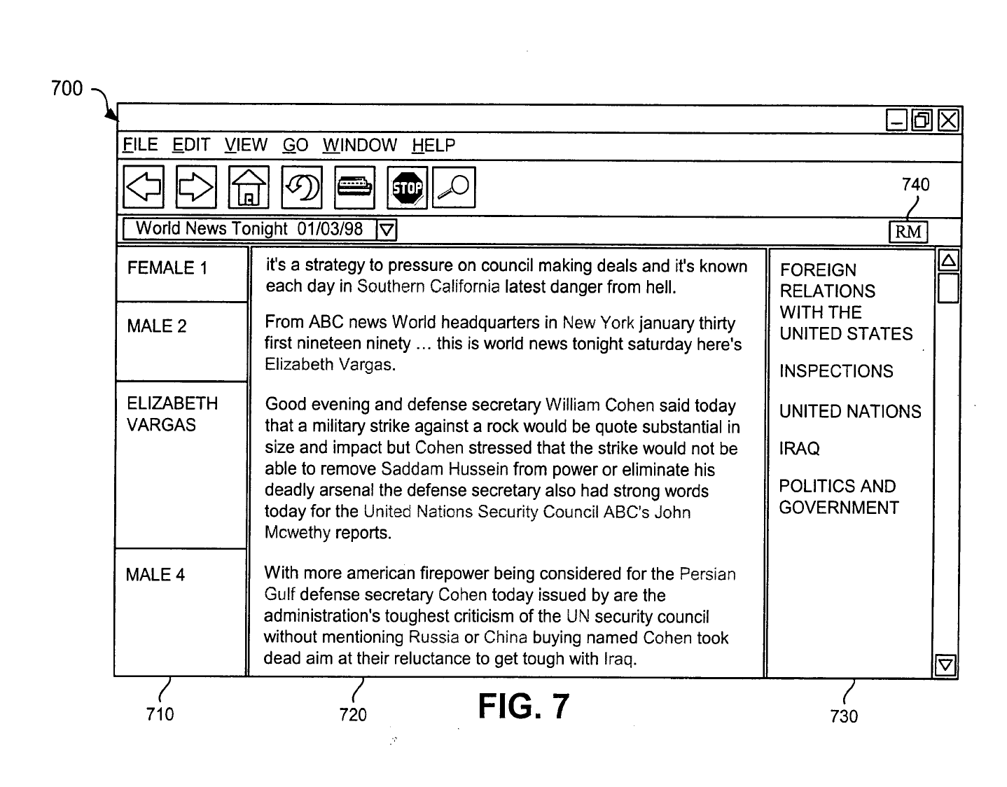

In an implementation consistent with the principles of the invention, client 140 provides a textual representation of a desired media in any language via a graphical user interface (GUI). FIG. 7 is a diagram of an exemplary GUI 700 that client 140 may present to a user according to an implementation consistent with the principles of the invention. GUI 700 may be part of an interface of a standard Internet browser, such as Internet Explorer or Netscape Navigator, or any browser that follows World Wide Web Consortium (W3C) specifications for HTML. The information presented by GUI 700 in this example relates to an episode of a television news program (i.e., ABCs World News Tonight from Jan. 31, 1998).

GUI 700 may include a speaker section 710, a transcription section 720, and a topics section 730. Speaker section 710 may identify boundaries between speakers, the gender of a speaker, and the name of a speaker (when known). In this way, speaker segments are clustered together over the entire episode to group together segments from the same speaker under the same label. In the example of FIG. 7, one speaker, Elizabeth Vargas, has been entitled by name.

Transcription section 720 may include a transcription of the desired media. Transcription section 720 may identify the names of people, places, and organizations by highlighting them in some manner. For example, people, places, organizations may be identified using different colors. Topic section 730 may include topics relating to the transcription its transcript on section 720. Each of the topics may describe the main themes of the episode and may constitute a very high-level summary of the content of the transcription, even though the exact words in the topic may not be included in the transcription.

GUI 700 may also include a request media (RM) icon 740 corresponding to an embedded media player, such as the RealPlayer media player available from RealNetworks, that permits the original media corresponding to the transcription in transcription section 720 to be played back. When instructed to do so, such as when a user selects icon 740, the media player may access database of original media 130 to retrieve the original media and present the original media to user. For example, if the original media is an audio stream, the media player may permit the original audio to be played. Similarly, if the original media is a video stream, the media player may permit the original video to be played. If the original media is to text stream, the media player may present the original text document.

### Exemplary Processing

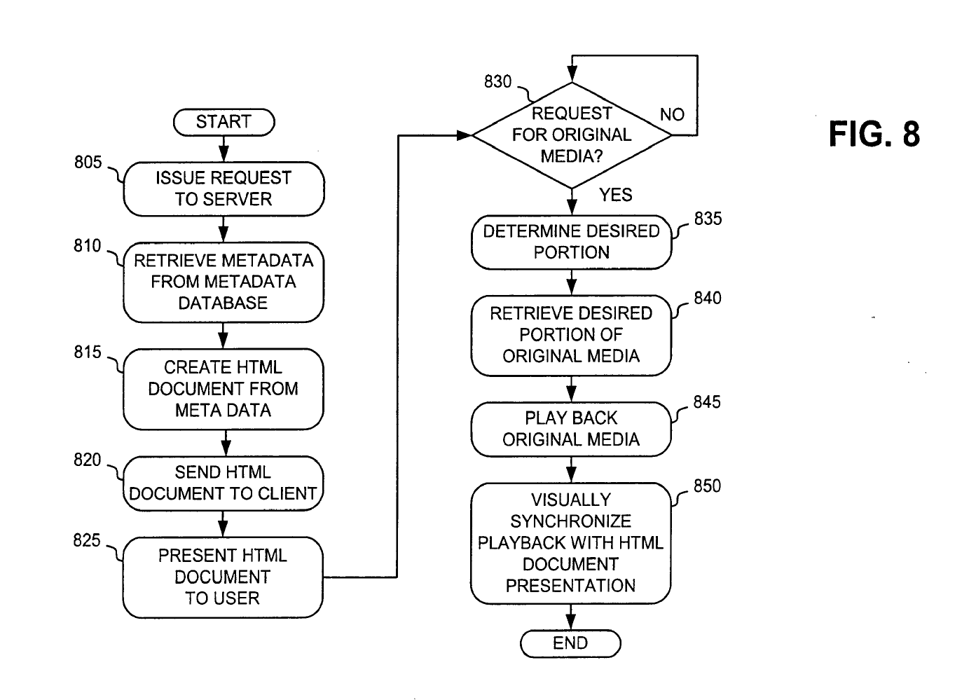

FIG. 8 is a flowchart of exemplary processing for visually synchronizing the playback of an original media with a textual representation or the media. Processing may begin with a user inputting, into client 140, a request for desired information. The information desired by the user may have originated in any form (e.g., text, audio, or video) and in any language e.g., English, Chinese, or Arabic). A typical request may be as specific as “give me ABCs World News Tonight for Jan. 3, 1998,” or as general as “show me everything where Bill Clinton was the topic.” Other requests may include data regarding the date, time, and source of the desired information, or relevant words next to each other or within a certain distance of each other (similar to a typical database query).

Client 140 may process (e.g., convert) the request, if necessary, and issue the request to server 110 (act 805). For example, client 140 may establish communication with server 110 via network 150, using conventional techniques. Once communication has been established, client 140 may transmit the request to server 110.

Server 110 may formulate a query based on the request from client 140 and use the query to access metadata database 120. Server 110 may retrieve metadata relating to the desired information from metadata database 120 (act 810). Server 110 may then convert the metadata to an appropriate form, such as an HTML document, and transmit the HTML document to client 140 for display in a standard web browser (acts 815 and 820). The HTML document may contain the original metadata information, such as speaker identifiers, topics, and word time codes. In other implementations, server 110 may convert the metadata to another form or transmit the metadata unconverted to client 140.

Client 140 may present the HTML document to the user via a GUI, such as GUI 700 (act 825). The user may read, skim, or browse the HTML document. At some point, the user may express a desire to play back the information in the HTML document in its original form (act 830). In this case, the user may highlight or otherwise identify a portion of the HTML document for which the user desires to obtain the original media and select request media icon 740. For example, the user may use a computer mouse to highlight the desired portion. Alternatively, the user may simply identify a starting point from which the original media is desired.

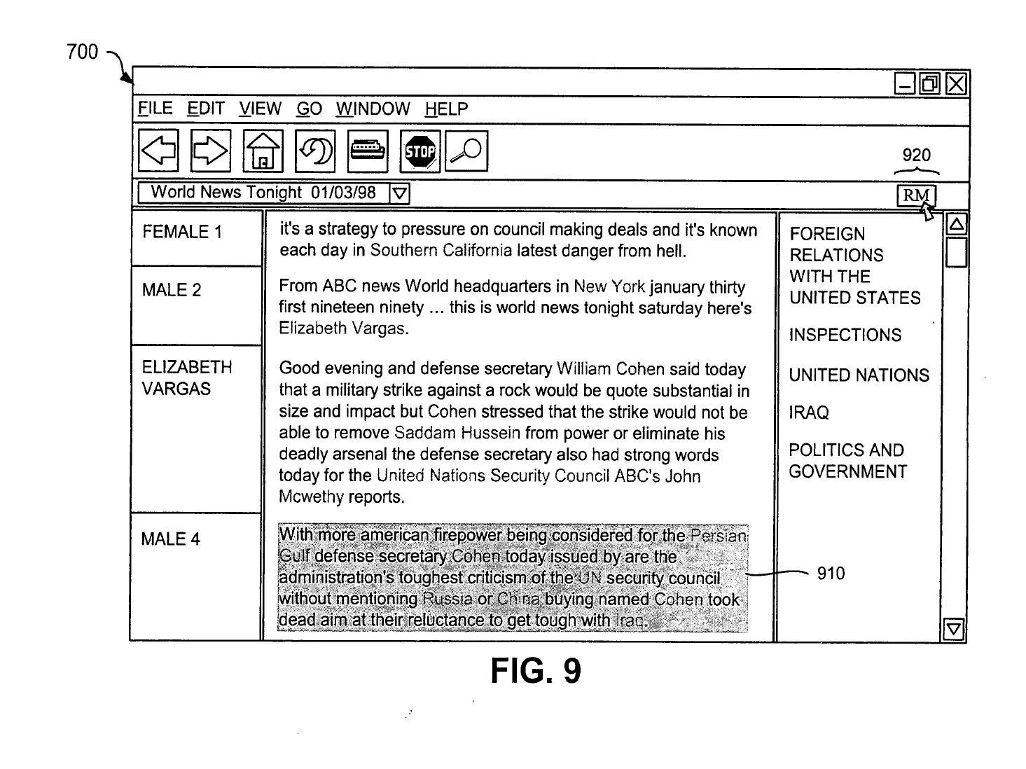

FIG. 9 is a diagram of GUI 700 that illustrates a user's request to play back an original media. The user highlights a portion of the HTML document at highlighted block 910. The user selects the request media icon 920 to initiate the playback process.

Returning to FIG. 8, when the user selects request media icon 740 (FIG. 7) client 140 initiates the embedded media player. The media player may determine the portion identified by the user, such as highlighted portion 910 (act 835). In particular, the media player may identify the time codes, corresponding to the beginning and ending (if applicable) of the identified portion, using the time codes in the HTML document.

The media player may then retrieve the desired portion of the original media (act 840). The media player may use conventional techniques to pull that portion of the original media from database of original media 130. For example, the media player may use the beginning and ending time codes (e.g., 7:03 p.m. to 7:05 p.m.) when accessing database 130. The original media from database 130 streams back to the media player. The media player then plays the original media for the user (act 845).

As the media player plays back the original media, GUI 700 visually synchronizes the playback with the transcription in the HTML document (act 850). To facilitate this, the media player lets cheat 140 know as time passes in the playback of the original media. Because the metadata of the HTML document includes time codes that identify exactly when each word in the transcription of the HTML document as spoken, client 140 knows precisely (possibly down to the millisecond) when to highlight (or otherwise visually distinguish) a word. Client 140 compares the times emitted by the media player with the time codes and highlights the appropriate words.

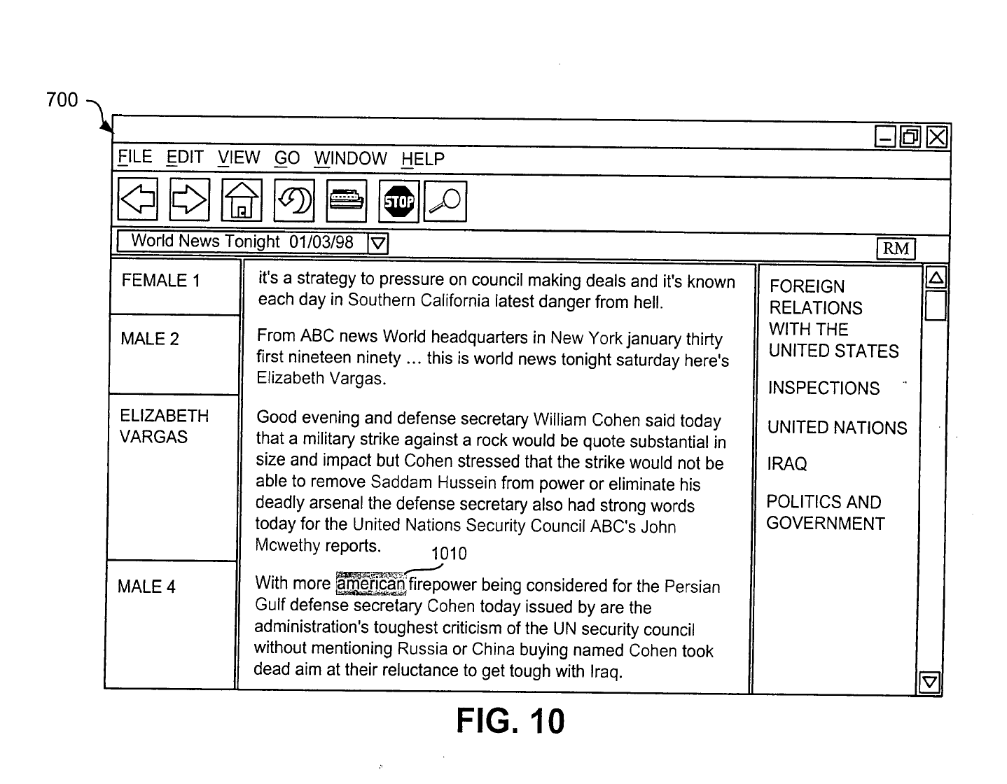

FIG. 10 is a diagram of GUI 700 that illustrates the synchronization of the HTML document to the playback of the original media. Client 140 visually distinguishes the word “american” in synchronism with the playback of the original media (audio, video) by the media player, as shown at the highlighted block 1010.

The user may be permitted to stop the playback at any time. The user may also be permitted to control the playback by, for example, fast forwarding, speeding it up, slowing it down, or backing it up so many seconds or so many words. The media player or the graphical user interface may present the user with a set of controls to permit the user to perform these functions.

The user may also be permitted to alter the HTML document in some manner and save the altered document back in metadata database 120. For example, the user ma be permitted to highlight or comment on the document. Client 140, in this case, may send the altered document back to server 110 for storage in metadata database 120.

### CONCLUSION

Systems and methods consistent with the present invention visually synchronize the playing back of a type of media, such as text, audio, and/or video, with a textual representation of the media. The systems and methods may highlight or otherwise visually distinguish words in the textual representation in synchronization with the playing back of the media. Such systems and methods permit a user to quickly browse the media in any language.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

For example, it has been disclosed that a media player retrieves the original media once initiated by the client. In other implementations, the original media may be transmitted to the client alone with the HTML document containing the metadata. In yet other implementations, more than the requested portion of the original media may be transmitted to the client in anticipation of its later request by the user.

It may also be possible to send the HTML document to the client without time codes. In this case, the client would need to request the time codes of the selected portion so that the playback of the original media can be synchronized with the textual representation of the media.

No element, act, or instruction used in the description of the present application should be construed as critical or essential to the invention unless explicitly described as such. Also, as used herein, the article “a” is intended, to include one or more items. Where only one item is intended, the term “one” or similar language is used. The scope of the invention is defined by the claims and their equivalents.

1-35. (canceled)

36. A graphical user interface, comprising:
a transcription section that includes a transcription of non-text information;
a speaker section that identifies boundaries between speakers in the transcription section;
a topic section that includes one or more topics relating to the transcription; and
a request media button that, when selected, causes:
retrieval of the non-text information to be initiated,
playing of the non-text information, and
the playing of the non-text information to be visually synchronized with the transcription in the transcription section.

37. The graphical user interface of claim 36, wherein the transcription visually distinguishes names of people, places, and organizations.

38. The graphical user interface of claim 36, wherein the speaker section further includes at least one of gender and names of the speakers.

39. The graphical user interface of claim 36, wherein the one or more topics relate to one or more main themes of the transcription.

40. The graphical user interface of claim 36, wherein the transcription includes time codes that identify when words in the transcription were spoken with regard to the non-text information.

41. The graphical user interface of claim 40, wherein the request media button causes words in the transcription to be visually distinguished in synchronism with the words in the non-text information being played.

42. The graphical user interface of claim 36, wherein the non-text information includes at least one of audio and video.

43. The graphical user interface (GUI) of claim 36, wherein the transcription is presented in any language not limited to a single language and wherein the non-text information originated in said any language not limited to said single language.

44. The GUI of claim 37, wherein the people, places, and organizations are distinguished using a different color for each of said people, said places and said organizations.

45. The GUI of claim 36, wherein the transcription is presented to a user of said GUI as an HTML document to permit the user to highlight or otherwise identify (1) a portion of the HTML document for which the user desires to obtain said non-text information or (2) a starting point in the HTML document from which subsequent said non-text information is desired by said user, said user obtaining said portion of said non-text information or said subsequent non-text information by operating said request media button.

46. The GUI of claim 45, wherein the user may alter the HTML document by highlighting on the document and storing the highlighted document in a metadata database.

47. The GUI of claim 45, wherein the user may alter the HTML document by commenting on the document and storing the commented document in a metadata database.

48. The GUI of claim 45, wherein the non-text information may be transmitted to a client along with the HTML document without need for said operating said request media button.
